(19) United States
(12) Patent Application Publication
(10) Pub. No.: US 2012/0075619 A1
(43) Pub. Date: Mar. 29, 2012

(54) FIBER-OPTIC PROBES AND ASSOCIATED METHODS

(76) Inventors: Linda T. Nieman, (US); Konstantin Sokolov, Austin, TX (US)

(21) Appl. No.: 13/043,043

(22) Filed: Mar. 8, 2011

Related U.S. Application Data
(63) Continuation-in-part of application No. PCT/US09/66730, filed on Dec. 4, 2009.
(60) Provisional application No. 61/120,206, filed on Dec. 5, 2008.
(60) Provisional application No. 61/312,013, filed on Mar. 9, 2010.

(51) Int. Cl. G01J 3/28; G01N 21/64; G01B 9/02; G01N 21/55; G02B 6/00; G01N 21/00

(52) U.S. Cl. 356/72; 385/12; 356/326; 356/73; 356/445; 250/459.1

(57) ABSTRACT

Fiber-optic probes are provided comprising an illumination fiber and a plurality of collection beveled fibers. In some embodiments, the fiber-optic probes may further comprise a collection flat-tip fiber. A system comprising a fiber-optic probe operably connected to a spectrometer, wherein the fiber-optic probe comprises an illumination fiber and a plurality of collection beveled fibers is provided. Associated methods are also provided.

### CROSS-REFERENCE TO RELATED APPLICATIONS

This application is a continuation-in-part of International Application No. PCT/US09/66730 filed Dec. 4, 2009, which claims the benefit of U.S. Provisional Application No. 61/120,206 filed Dec. 5, 2008; this application also claims the benefit of U.S. Provisional Application No. 61/312,013 filed Mar. 9, 2010, all of which are incorporated by reference.

### STATEMENT OF GOVERNMENT INTEREST

This invention was made with government support under NIH-EB003540 awarded by National Institutes of Health. The U.S. government has certain rights in the invention.

### BACKGROUND

Early detection is the key to treating cancer. In humans, 85 percent of all cancer originates in the epithelial tissue, including the esophagus, colon, lung, bladder, and cervix. There is currently no way to detect and locate these cancers in vivo until they have developed into a visible lesion, at which time they may have already metastasized and spread. Traditional invasive biopsy can be painful, inaccurate, and time consuming. Optical imaging is a new modality which is inexpensive, robust, and portable. Optical imaging systems are ideally suited for early detection of epithelial disease.

Optical spectroscopy has shown great promise discriminating cancers by detecting changes in the optical properties of human tissues. However, identification of precancerous disease states such as mild or moderate dysplasia from benign conditions has proven more difficult to achieve. It is well known that the optical properties of tissue change with precancer development and differ according to tissue depth. The epithelial layer, where the vast majority of cancers originate, occupies the first few hundred microns of tissue. The epithelial layer is optically thin but the underlying stromal tissue is highly turbid. As a consequence, the stromal signal dominates a typical measured optical spectrum, obscuring the depth dependent micro-optical changes that occur with precancer development.

Cancer is the second leading cause of death in the U.S., and as previously stated, the majority of cancers are of epithelial origin. Early diagnosis of pre-invasive epithelial neoplasia, as may be enabled by sensitive and cost-effective screening techniques, is important in reducing the mortality of cancer. Current clinical diagnosis of morphological and molecular changes associated with early carcinogenesis can only be assessed by invasive biopsy. The rise in cancer in the industrialized world has resulted in an increasing acceptance of biopsy devices. Although nearly 80 percent of biopsies turn out to be benign, there is usually no other way to determine whether or not the abnormality is cancer. In fact, biopsy with histopathological analysis is considered the gold standard for various forms of cancer.

### SUMMARY

The present disclosure generally relates to fiber-optic probes. More particularly, the present disclosure relates to fiber-optic probes comprising one or more beveled fibers and associated methods.

In one embodiment, the present disclosure provides a fiber-optic probe comprising an illumination fiber and a plurality of collection beveled fibers. In another embodiment, the present disclosure provides a system comprising a fiber-optic probe operably connected to a spectrometer, wherein the fiber-optic probe comprises an illumination fiber and a plurality of collection beveled fibers. The present disclosure also provides methods of imaging a tissue sample using a fiber-optic probe of the present disclosure.

### DRAWINGS

The patent or application file contains at least one drawing executed in color. Copies of this patent or patent application publication with color drawing(s) will be provided by the Office upon request and payment of the necessary fee.

Some specific example embodiments of the present disclosure may be understood by referring, in part, to the examples following and the accompanying drawings.

FIG. 1A is an illustration of a fiber-optic probe design, according to one embodiment, utilizing a collection flat-tip fiber, an illumination flat-tip fiber, and a plurality of collection beveled fibers. In this illustration, there is no separation between the illumination flat-tip fiber and the collection beveled fiber BF0.

FIG. 1B is an illustration of a fiber-optic probe design, according to one embodiment, utilizing a collection flat-tip fiber, an illumination flat-tip fiber, and a plurality of collection beveled fibers. In this illustration, there is a separation between the illumination flat-tip fiber and the collection beveled fiber BF1.

FIG. 1C is an illustration of a fiber-optic probe design, according to one embodiment, utilizing a plurality of collection flat-tip fibers, an illumination flat-tip fiber, and a plurality of collection beveled fibers.

FIG. 1D is an illustration of a fiber-optic probe design, according to one embodiment, utilizing a plurality of collection beveled fibers and a plurality of beveled illumination fibers that are symmetrically positioned relative to a central spacing fiber.

FIGS. 2A-2B are illustrations of a fiber-optic probe, according to one embodiment, utilizing polarizers and a V-arrangement of collection fibers. A linearly polarized light is delivered through an illumination fiber at the tip of the V-arrangement and collection fibers detect light with polarization either parallel or orthogonal relative to the illumination polarization.

FIG. 3 is a cross-section image of the distal end of a fiber-optic probe along the axis indicated by the dashed line depicted in FIG. 2B.

FIGS. 4A-4C depict a fiber-optic probe design, according to one embodiment, utilizing an illumination fiber, a plurality of collection beveled fibers, and a plurality of collection flat-tip fibers.

FIG. 5 is a schematic diagram of the overall system, according to one embodiment.

FIGS. 6A-6C are graphs depicting depth profiling curves where the total intensity integrated over all wavelengths is plotted as a function of distance from the probe tip for bevel angles: (A) 35 degrees, (B) 40 degrees, and (C) 45 degrees.

FIG. 7A is a graph depicting the maximum probing depth as measured from the probe tip for each collection fiber.

FIG. 7B is a graph depicting the full width at half max (FWHM) as measured from the probe tip for each collection fiber.

FIG. 7C is a graph depicting the relative intensity for each collection fiber.

FIG. 8A is a transmittance brightfield image of a transverse cross-section through a three-layer bead phantom.

FIG. 8B is the scattering spectra of single layer bead phantoms corresponding to the top, middle, and bottom layer of a three-layer bead phantom.

FIG. 8C is the scattering spectra of single layer bead phantoms corresponding to the top, middle, and bottom layer of a three-layer bead phantom, plotted as a function of wavenumber.

FIG. 9 is a plot of a Fast Fourier Transform (FFT) power spectrum from a single layer phantom spectra showing the characteristic frequencies associated with each layer in a three layer phantom.

FIG. 10 is a representation of the measured spectra of a three layer phantom at zero probe-sample separation.

FIG. 11A is a plot of the FFT amplitude of the primary frequency component for each layer of a three layer phantom as a function of probe-sample distance.

FIG. 11B shows the depth profiling of collection fibers using a white substrate with illustration of the three-layer phantom shown above. The boundary between phantom layers indicated by thick black lines.

FIG. 12 is a representative in vivo measured spectra from inner lower lip (top) and dorsal tongue (bottom) of a normal volunteer.

FIG. 13A is a schematic diagram of the overall system, according to one embodiment.

FIG. 13B is an illustration of a fiber-optic probe design, according to one embodiment, utilizing a plurality of collection beveled fibers and a plurality of beveled illumination fibers that are symmetrically positioned relative to a central spacing fiber.

FIG. 14A are spectras from collection beveled fibers for various bladder types.

FIG. 14B is an analysis of variance (ANOVA) of the total perpendicular spectral intensity for each collection fiber.

FIG. 15A are unpolarized spectras from fibers for various bladder types.

FIG. 15B is a multivariate analysis of variance (MANOVA) of the spectral intensity for each collection fiber.

The patent or application file contains at least one drawing executed in color. Copies of this patent or patent application publication with color drawing(s) will be provided by the Office upon request and payment of the necessary fee.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure generally relates to fiber-optic probes. More particularly, the present disclosure relates to fiber-optic probes comprising one or more beveled fibers and associated methods.

In general, the present disclosure provides, according to certain embodiments, a fiber-optic probe comprising one or more illumination fibers and a plurality of collection beveled fibers. In some embodiments, in addition to collection beveled fibers, a fiber-optic probe of the present disclosure may also comprise one or more collection flat-tip fibers. In some embodiments, the fiber-optic probes of the present disclosure are able to collect optical signals from multiple layers within a tissue sample, such as sub-layers within the superficial epithelial tissue and underlying stroma.

One of the many potential advantages of the fiber-optic probes of the present disclosure is that through the use of beveled fibers, the probes of the present disclosure may, among other things, measure optical signals from multiple depths within a sample. The present disclosure is based, at least in part, on the observation that separate interrogation of epithelial and stromal layers may improve the ability to detect alterations in tissue optical properties, for example, to distinguish dysplasia and carcinoma from normal mucosa and benign conditions as a result of alterations in tissue optical properties during carcinoma development. Thus, in some embodiments, the fiber-optic probes of the present disclosure may be capable of performing an interrogation of multiple tissue layers, thus improving, for example, the ability to distinguish dysplasia and cancer from normal mucosa and benign conditions.

In some embodiments, the fiber optic probes of the present disclosure may allow for rapid optical measurements with real-time diagnostic feedback and work for reflectance spectroscopy, fluorescence spectroscopy, and Raman spectroscopy. In certain embodiments, an additional advantage of the fiber-optic probes of the present disclosure is its manufacturing simplicity and low cost. In some embodiments, the fiber-optic probes have no moving parts and contain fewer components than traditional probes, thereby permitting the construction of a disposable device. Furthermore, in some embodiments, the fiber-optic probes of the present disclosure may benefit health care by reducing the number of unnecessary invasive biopsies as well as by enabling combined diagnosis and therapy.

In some embodiments, fiber-optic probes of the present disclosure may be used as a stand-alone instrument or as an accessory to standard endoscopes and needle biopsies to monitor treatment, to detect cancerous cells, for photo-thermal therapy, to guide biopsies, to demarcate lesion boundaries for surgical excision, etc. Thus, in certain embodiments, the fiber-optic probes may allow for improved detection of early stage cancers, improved targeted guidance of tissue biopsies, shortened endoscopy procedure times, and use in organ applications accessible by standard endoscopes (e.g., in vivo interrogation of many organ sites for the presence of early stage cancer). The fiber-optic probes of the present disclosure may also have other applications beyond those mentioned above where optical interrogation of depths within the first 1-2 millimeters of tissue is important, such as in dermatology.

In general, the fibers in the fiber-optic probes of the present disclosure are oriented normal to a surface of a sample, e.g., a tissue surface. This orientation allows for miniaturization, among other things, because it avoids the long-term bending radius of the fibers (approximately 300-400 times the fiber diameter), which is the minimum radius of curvature that an optical fiber can bend long-term without significant signal loss or mechanical failure. The fibers in the fiber-optic probes of the present disclosure may be formed from any fiber-optic material, such as, for example multi-modal fiber-optic materials and polarization maintaining fiber-optic materials.

As mentioned above, the fiber-optic probes of the present disclosure generally comprise an illumination fiber. An illumination fiber suitable for use in the fiber-optic probes of the present disclosure may comprise any fiber-optic material that is capable of delivering light to a tissue or sample region of interest. The light delivered from a illumination fiber is generally referred to herein as an “illumination beam” and may be any type of light capable of delivery through a fiber-optic material. A suitable type of light may be chosen depending on the desired application. For example, in one embodiment, an illumination fiber may deliver visible white light in the range of 400-900 nm to a tissue sample or sample region of interest. UV or NIR light (e.g., for fluorescence and NIR spectroscopy studies respectively) also may be delivered. Likewise, a laser light source can be used (e.g., for excitation of fluorescence). Additionally, the light may be linear, circular, or elliptically polarized. One of ordinary skill in the art will be able to select an appropriate light source depending upon the desired application.

In some embodiments, illumination fibers suitable for use in the fiber-optic probes of the present disclosure are flat-tip fibers (illumination FTFs). In some embodiments, illumination fibers suitable for use in the fiber-optic probes of the present disclosure are beveled (illumination BFs). In some embodiments, the use of a combination of beveled illumination fibers and symmetrically positioned collection beveled fibers can further improve depth resolution capabilities of the probe.

In addition to an illumination fiber, the fiber-optic probes of the present disclosure generally comprise a plurality of collection beveled fibers (collection BFs). In some embodiments, in addition to collection BFs, a fiber-optic probe of the present disclosure may also comprise one or more collection flat-tip fibers (collection FTFs). In general, both collection BFs and collection FTFs may be used to collect signals originating in a tissue or sample region of interest. In operation, collection fibers generally collect remitted photons. The area from which a signal may be collected by any particular collection fiber is generally referred to herein as a “collection cone.” In general, the collection depth of a particular collection fiber is a function of its distance from the illumination fiber, that is to say, the collection depth of a collection fiber generally increases as its distance from the illumination fiber increases. The distance between a particular collection fiber and the illumination fiber is sometimes referred to herein as the “source-detector separation.”

In some embodiments, collection BFs suitable for use in the fiber-optics probes of the present disclosure have a bevel angle between about 20 and about 60 degrees with respect to the fiber long axis, although smaller and larger angles may be used. The particular angle of the bevel will vary depending on the particular application. In general, a bevel angle may be chosen such that the fiber-optic probe comprising the beveled fiber has a desired collection efficiency and depth targeting ability. In certain embodiments, the bevel angle that provides the best compromise between depth resolution and collection efficiency is about 40 degrees. In some embodiments, depth resolutions may be in the range of about 0.1 mm to about 2.5 mm.

In addition to collection BFs, a fiber-optic probe of the present disclosure may also comprise one or more collection FTFs. In some embodiments, a collection FTF may be used to collect signals originating more deeply in a tissue or sample region of interest, and as a benchmark to evaluate the performance of the collection BFs. Collection FTFs generally collect signals from a slightly different angular range of exiting photons than collection BFs, and therefore, in some embodiments, collection FTFs can provide diagnostically useful information that is complementary to the information derived from the signal collected by the collection BFs. Collection FTFs can also be used with diffusion models of optical scattering within tissue, which is well understood.

In some embodiments, a fiber-optic probe of the present disclosure also comprises a window at the distal end of the probe. The window may function, among other things, to protect the fibers and also to maintain an air gap between the fibers the window. In some embodiments, the window may be transparent. In some embodiments, the window may be formed from, for example, fused silica, transparent plastic, etc. In some embodiments, the thickness of the window determines the depths that the collection fibers are able to sample. In some embodiments, the thickness of the window may be from about 50 μm to about 2000 μm.

In some embodiments, a fiber-optic probe may further comprise a polarizer, such as a polarizing film. For example, in some embodiments, a polarizing film may be placed on a surface of the window at the distal end of the probe. When used, a polarizer may be arranged in several different configurations. In some embodiments, use of a polarizer may provide additional depth gating/depth resolution and optical information that can be used to further enhance diagnostic discrimination.

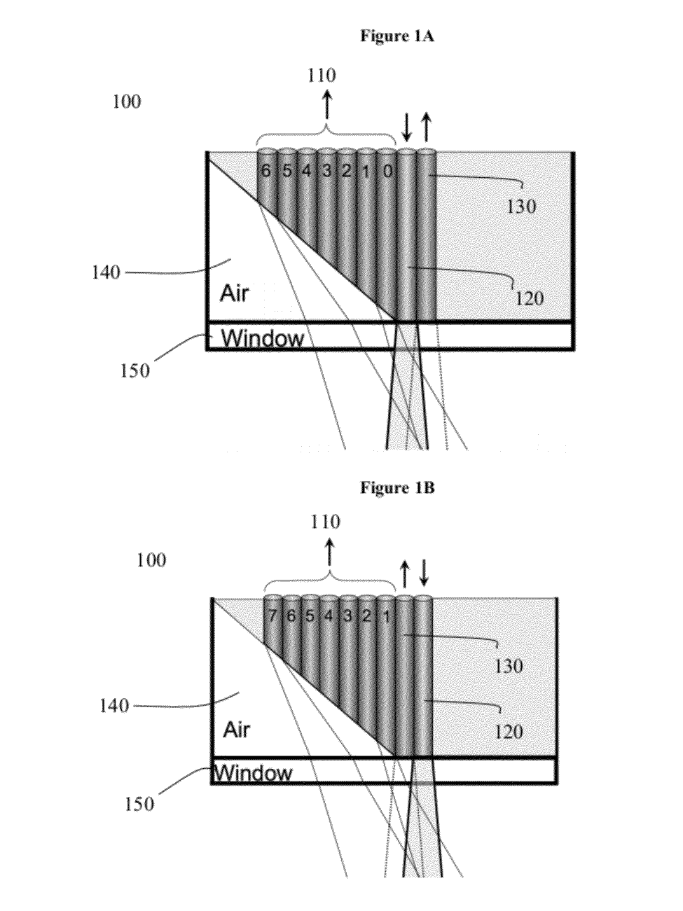

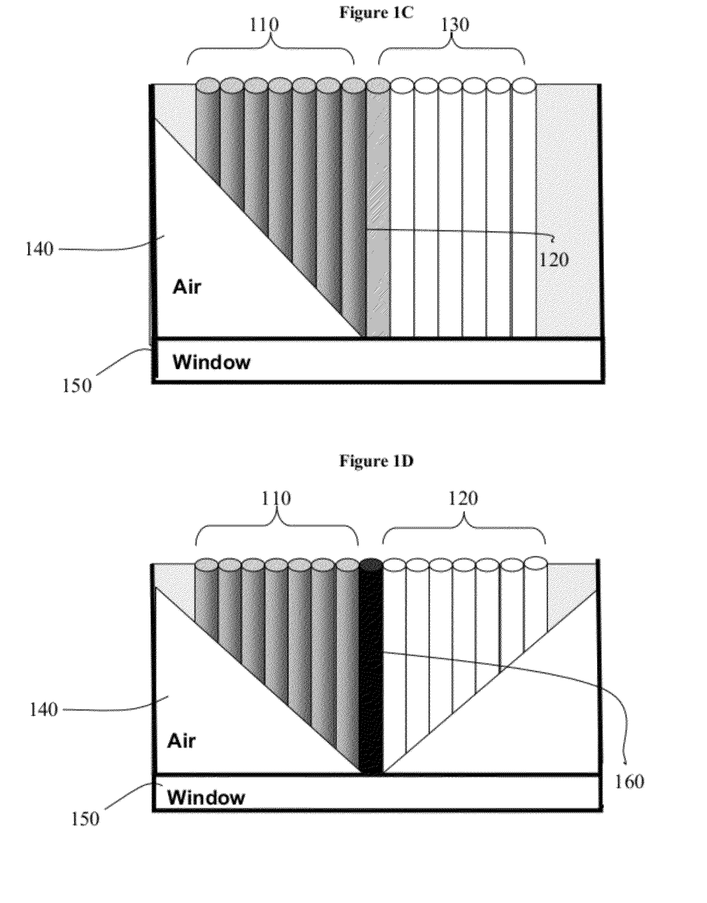

Turning to the drawings and referring first to FIGS. 1A and 1B, depicted are schematic diagrams of an example fiber-optic probe 100, according to specific example embodiments of the present disclosure. Fiber-optic probe 100 comprises a plurality of collection BFs 110, a single illumination FTF 120, (a plurality of illumination FTFs also may be used (not shown), a single collection FTF 130 (a plurality of collection FTFs also may be used (not shown)), and a window 150. An air gap 140 between the collection BFs 110 and window 150 provides a large refractive index change to deviate the collection cone of a given collection fiber, thereby providing an overlap between the illumination beam from illumination FTF 120 and the collection cones of collection BFs 110 and collection FTF 130 at different depths within tissue. The size and range of the air gap is determined by the beveled angle of the collection BFs and the number of BFs. Similarly, the size and range of the air gap may be tailored to suite a particular application.

In principle, in some embodiments, fibers closest to illumination FTF 120 sample the superficial-intermediate layer of tissue, and those fibers farthest from illumination FTF 120 sample deeper tissue regions. In some embodiments, collection FTF 130 may be used as a standard for comparing the performance of the collection BFs 110 and to interrogate deeper tissue optical properties.

The fibers of the fiber-optic probes of the present disclosure may be oriented in any suitable configuration. In one embodiment, as shown in FIG. 1A and FIG. 1B, the fibers may be oriented along the same axis. One benefit of such an orientation, as opposed to an oblique orientation, is that it avoids the fabrication complication posed by polishing obliquely oriented fibers where the separation between an illumination fiber and a collection fiber is dependent on the amount of polishing. It should be noted, however, that oblique orientations are contemplated by the present disclosure. In another embodiment, collection fibers may be arranged in concentric rings around an illumination fiber.

In some embodiments, all fibers are in direct contact with their nearest neighbor. In such implementations, the fibers may have a core/clad diameter of about 100/110 microns and a numerical aperture (NA) of about 0.12. In general, the fiber NA may be chosen such that the axial extent of the overlap of the illumination beam and collection cones would be sufficiently small to allow probing of sub-layers within the epithelium.

The fibers may be secured into a fiber-optic probe of the present disclosure using a variety of suitable approaches. For example, in one embodiment, a biocompatible epoxy may be used to secure the fibers. Additionally, the fibers may be housed in a variety of suitable manners. For example, in one embodiment, the fibers may be housed inside a stainless steel tube of a sufficient diameter and length. In some embodiments, the fibers may be housed inside non-metal materials for compatibility with MRI, CT, etc.

In certain embodiments, multiple collection FTFs 130 may be used, for example, to sample deeper regions within a tissue sample (An example is shown in FIG. 1C.) As with the collection BFs, collection FTFs farther from the illumination fiber will collect a signal from areas that are located deeper in the tissue sample. The use of multiple collection FTFs can be used to extract out deeper tissue optical properties as compared to the collection BFs. Multiple illumination FTFs also may be used.

In certain embodiments, multiple illumination fibers and multiple collection fibers may be used. Collection fibers in these configurations may include collection BFs, collection FTFs, or a combination thereof. Configurations using both multiple illumination fibers and multiple collection fibers may be configured in a variety of arrangements. For example, as shown in FIG. 1D, collection BFs 110 and illumination fibers 120 may mirror each other relative to a central spacing fiber 160. In such configurations, each collection fiber has an illumination fiber that is located at the same distance from the central spacing fiber. These pairs can be used to collect signals from different depths in tissue. As noted above, the pairs which are further away from the central spacing fiber collect a signal from areas that are deeper in the tissue sample. In some embodiments, this arrangement, among other things, may improve depth resolution and efficiency of collection of scattered or re-emitted photons.

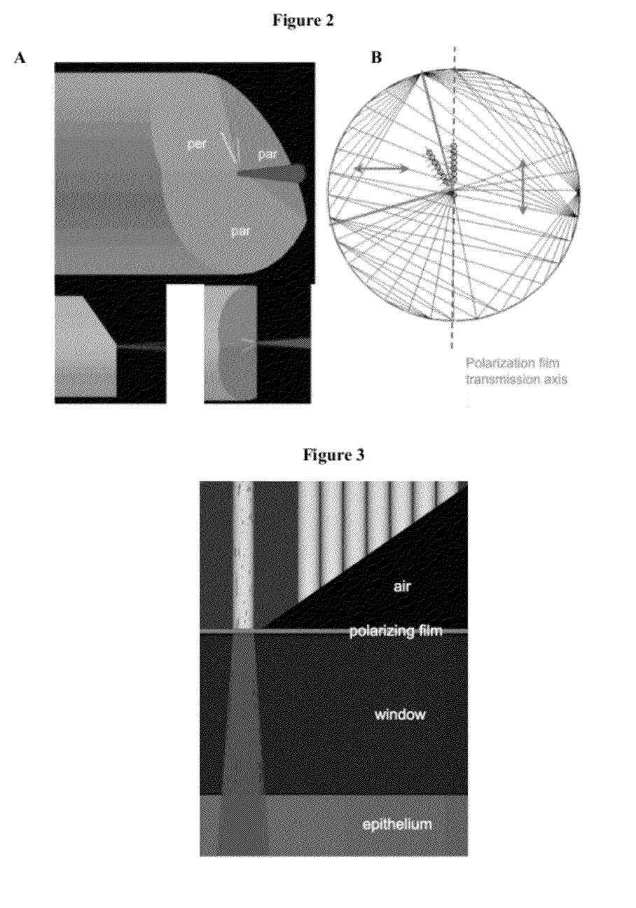

The three-dimensional configuration of a fiber-optic probe of the present disclosure may be tailored to reduce the overall diameter of the probe. In some embodiments, a fiber-optic probe of the present invention may have a diameter of less than 3 millimeters. In some embodiments, a fiber-optic probe of the present invention may have a diameter of less than 2 millimeters. In some embodiments, a fiber-optic probe of the present disclosure may have a diameter of about 0.5 to 1 millimeter. One example of a configuration designed to reduce the overall diameter of a fiber-optic probe of the present disclosure is shown in FIG. 2A, which shows a three-dimensional rendering of the distal end of a fiber-optic probe where the collection fibers are oriented in a V-arrangement in order to reduce the diameter of the probe. Each set of collection fibers collects light with polarization either parallel or orthogonal relative to the illumination polarization depicted in FIG. 2B, but polarization is optional and is not limited to these orientations. The polarizing film placed on the window determines the polarization orientation of the collected light. The arrows in FIG. 2B indicate the transmission axes of the polarizing films. The angle between the transmission axes can vary from about 0 to about 90 degrees. The orientation of the transmission axes of the polarizing film can provide sensitivity to diagnostically relevant tissue morphology such as, for example, average nuclear size.

FIG. 3 is a cross-section image of the distal end of a fiber-optic probe along the axis indicated by the dashed line depicted in FIG. 2B. The polarizing film determines the polarization orientation of the collected light. In some embodiments, a polarizing film may be placed on the backside of the window.

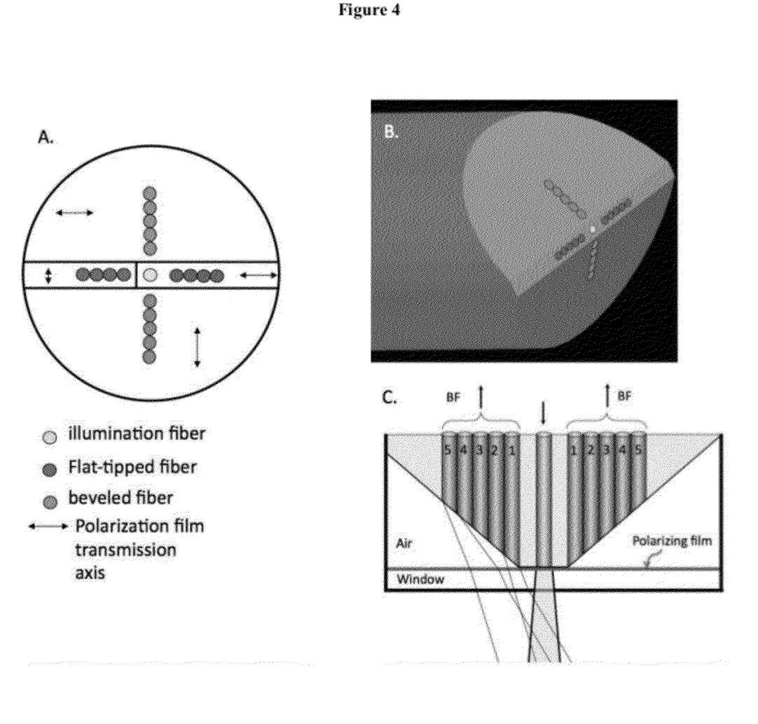

FIG. 4A illustrates a distal end of a fiber-optic probe according to one embodiment of the present disclosure that is polarization sensitive and is configured to have collection FTFs symmetrically placed on either side of the illumination fiber. In one embodiment, each set of fibers is separated by 180 degrees. The polarization, or electric field orientation, of the collected signal is determined by the placement of the polarizing films. The transmission axes of the polarizing films are indicated by the arrows. Each set of collection fibers collects light with polarization either parallel or orthogonal to the illumination polarization, but polarization is not limited to these configurations. FIG. 4B shows a three-dimensional shaded rendering of the distal end of a fiber-optic probe that shows three different polished faces at the distal end of the probe. FIG. 4C is a cross-section image of the distal end of a fiber-optic probe taken along the axis containing the collection BFs and the illumination fiber. As shown in FIG. 4C, a polarizing film is adhered to the backside of the window.

In other embodiments, the present disclosure provides a spectroscopic fiber-optic probe system comprising: a fiber-optic probe of the present disclosure operably connected to a spectrometer. In such systems, the fiber-optic probe may be used with other established and/or emerging imaging technologies such as Magnetic Resonance Imaging (MRI), Computed Tomography (CT), Positron Emission Tomography (PET) and cystoscopy to improve sensitivity and specificity in detection of pathology. For example, MRI, CT, or PET may be used to survey large tissue volumes and to detect areas that are suspicious for pathology and a spectroscopic fiber-optic probe system of the present disclosure can be used to survey these suspicious regions to increase specificity of detection. In another example, MRI, CT, or PET may be used to detect pathology and a spectroscopic fiber-optic probe system of the present disclosure can be used during a surgical procedure to delineate margins for surgical removal. The spectroscopic fiber-optic probe system also may be used in combination with Optical Coherence Tomography (OCT) in a multimodal approach providing complementary biochemical and morphological information wherein depth-resolved spectroscopic information can be correlated with depth-resolved tissue morphology and architecture provided by OCT.

In yet other embodiments, the present disclosure provides methods comprising: placing a fiber-optic probe of the present disclosure adjacent to a tissue; interrogating the tissue with the fiber-optic probe; and determining alterations in optical properties of the tissue. In such methods, the fiber-optic probe may be configured to rapidly measure optical signals from multiple depths with real-time diagnostic feedback for, among other things, improved early detection of cancers, improved targeted guidance of biopsies, shortened endoscopy procedure time, and use in organ applications accessible by standard endoscopes. Real-time diagnostic feedback may comprise the use of statistical algorithms or algorithms based on physical models or both.

In some embodiments, interrogating a tissue sample with a fiber-optic probe of the present disclosure involves collecting optical signals (e.g., remitted light) from sub-layers within a tissue (e.g., a living tissue) or sample region of interest. In certain embodiments, each sub-layer within a tissue or sample region of interest may be interrogated separately. The interrogation of multiple depths within a tissue or sample region of interest may comprise optical measurements in a range of nanoseconds to about 30,000 ms. Similarly, separate regions may be measured sequentially (i.e., one at a time) or all at once. While any sample capable of being imaged is suitable for use in the methods of the present disclosure, the methods of the present invention my be particularly suitable for imaging tissue of epthelial origin, including, but not limited to tissue of the esophagus, colon, lung, bladder, and cervix.

In another embodiment, a fiber-optic probe of the present disclosure may be used in conjunction with contrast agents such as fluorescent dyes, stains, quantum dots, and/or nanoparticles. In one embodiment, the present disclosure provides methods of using a fiber-optic probe of the present disclosure in conjunction with a contrast agent, such as plasmonic nanoparticles, to detect vulnerable plaques in arterial tissue. In some embodiments, plasmonic nanoparticles may be specific to molecular signatures of cardiovascular plaques that include, but are not limited to, macrophages, intergrins, selectins, and metalloproteases.

Therefore, the present disclosure provides, in certain embodiments, methods that may be useful to, among other things, diagnose cancer, stage cancer, monitor cancer, improve tumor margin detection, improve detection of atherosclerotic disease. Such methods also may be useful to determine endogenous tissue contrast and distribution and concentration of exogenous contrast agents.

To further illustrate various illustrative embodiments of the present invention, the following examples are provided.

### EXAMPLE 1

Fiber-Optic Probe Fabrication

The first step in the probe fabrication was alignment of the optical fibers along the same plane. Bare optical fibers were laid flat on a microscope slide and held in place with double-sided tape. A small amount of low viscosity biocompatible epoxy (Epo-Tek 301-2) was applied to the fibers. Capillary forces wicked the epoxy between the fibers. After the epoxy hardened, the fibers were bathed in ethanol to remove the fibers from the microscope slide. Then, the fiber ribbon was inserted into a stainless steel cylinder 10-15 mm long that had a slot cut into it. The stainless steel cylinder was beveled prior to inserting the fibers. The end of the fiber ribbon extended beyond the end of the steel cylinder approximately 1 cm. Epoxy was added to secure the ribbon fiber inside of the steel disk. After the epoxy hardened, the fiber excess was cleaved. Using a custom made fiber polishing puck, the end of the stainless steel disk and fibers were polished to a 0.1 mm finish. This polishing procedure was performed to the collection BFs and then to the FTF surfaces. The final polished distal end was inserted into an annealed stainless steel (316L) tube approximately 4.5 mm in diameter and 30 cm long. The same biocompatible epoxy used in the previous steps was applied to secure the fibers and the stainless steel disk inside of the steel tube. Afterward, a protective window 160 μm thick was placed on the distal end of the probe to protect the fibers and to maintain an air gap.

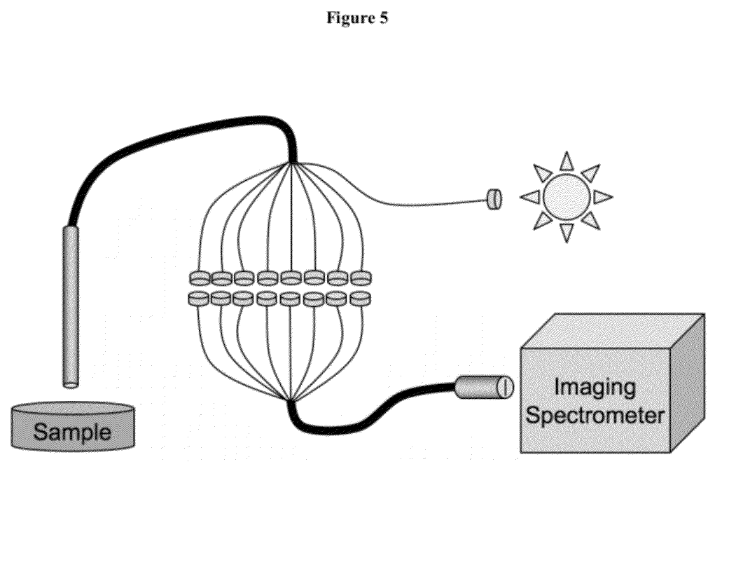

FIG. 5 shows the overall system schematic. This arrangement is modular, thereby permitting testing of multiple probe designs. The proximal ends of the collection fibers were connected to a coupling fiber bundle (RoMack, Inc.) via FC/APC adapters. FC/APC terminators were chosen for their low insertion loss (ca. 0.15 dB). The fibers of the coupling fiber bundle (100/110 core/clad, 0.22 NA) were stacked in a vertical array and aligned with the entrance slit of the imaging spectrograph (PI Acton SpectraPro SP-2356, Pixis 2KB). The triple grating spectrograph had a 150 g/mm and 300 g/mm grating optimized for visible wavelengths (500 nm blaze) and a theoretical spectral resolution of 0.714 nm and 0.353 nm, respectively. The spectrograph disperses the light from each fiber onto the imaging CCD. The image produced by the CCD has the vertical spatial dimension along the y-axis and the wavelength dimension along the x-axis. With this arrangement, the spectrum from all collection fibers can be acquired in a single image. After image acquisition, the image was masked into multiple strips, where each strip corresponded to the position of a fiber at the entrance slit. Each strip was then binned vertically to yield the intensity versus wavelength spectrum. Dark subtraction and post-processing was performed with MATLAB® R7 software.

Depth Selectivity of Fiber-Optic Probe

The depth selectivity of the fiber-optic probe was characterized using a diffuse white scatterer that was composed of white Teflon tape atop of a thick glass substrate. This sample mimicked the ideal case of an infinitely thin diffuse scatterer.

The sample was placed on a moveable translation stage so that its height could be adjusted, while the probe was fixed in a holder directly above it. Measurements were performed with the collection fibers depicted in FIG. 1B. The separation between the probe and the sample was controlled using a fine-pitched micrometer screw. The initial distance of the probe from the sample was set at 3 mm. Water was added between the substrate and the probe for index matching. Using the micrometer, the substrate was gradually brought closer to the probe. The signal intensity (integrated over all wavelengths) was measured for each fiber at each probe-sample separation. Three bevel angles were evaluated: 35, 40, and 45 degrees (relative to the long axis of the fibers). For each bevel angle, the depth profiling experiment was performed in triplicate.

Additionally, to explore the depth profiling of a collection BF with no separation between the illumination FTF and the collection beveled fiber BF0, the fiber-optic probe shown in FIG. 1A was employed. Measurements were taken in a similar manner as described above for the thin white substrate.

Phantom Experiments

In order to evaluate the sectioning ability of an example fiber-optic probe design in vivo, signal intensity measurements were taken on multilayer phantoms mimicking the optical scattering properties of precancerous epithelial tissue. A three layer phantom was prepared using polystyrene beads (BangsLabs, Inc.) embedded in 3% w/v agarose. The top, middle, and bottom phantom layers were prepared using 5.01±0.14 μm, 8.31±0.66 μm, 2.50±0.16 μm beads, respectively. The manufacturer refractive index of the beads was 1.59. The refractive index of the agarose was measured to be 1.335 with a refractometer (Bausch and Lomb). The beads were diluted from stock solution to give scattering coefficients approximating epithelial (top layer, ca. 33 cm⁻¹), precancerous (middle layer, ca. 71 cm⁻¹), and stromal tissue (bottom layer, ca. 189 cm⁻¹). Bead concentrations were calculated using Mie theory. The three layer configuration simulated the development of mild to moderate dysplasia where basal cells proliferate, encompassing the bottom ⅓ to ⅔ of the epithelium. First, the bottom layer was fabricated by pipetting the warm bead-agarose mixture into a cylindrical well 12 mm in diameter and 6 mm deep. The cylindrical well was machined from an aluminum slab ca. 10 cm×3 cm×3 cm. A glass microscope slide was placed atop the phantom to ensure a flat upper surface. After the bottom layer solidified, the glass slide was removed and two no. 1 glass coverslips approximately 160 μm thick were placed on either side of the bottom phantom on the top surface of the aluminum slab. The coverslips acted as spacers defining the thickness of the middle phantom layer. A bead-agarose mixture was prepared for the middle layer. The warm bead-agarose mixture was added to the upper surface of the bottom phantom layer. A microscope slide was quickly placed atop the new layer and gentle pressure was applied. After the middle layer solidified, the microscope slide was removed and another set of coverslips was placed atop of the previous pair. The top layer was then formed repeating the above procedure.

Single layer phantoms were also constructed for measurement of the pure scattering spectra from each layer. After the measurements, phantoms were transversely sliced into approximately 200-500 μm thick sections with a Krumdieck tissue slicer (Alabama Research and Development). Images were acquired with an optical microscope (Leica Microsystems, DM6000 M) in brightfield transmittance mode to characterize the morphology of the phantoms.

Three independent trials were performed for each phantom type. Measured spectra were dark subtracted and normalized by the spectrum from a white reflectance standard (Labsphere, SRS-99). All spectra were converted to wavenumber space for Fourier analysis. A fast Fourier transform (FFT) was taken of the measured spectrum for each single layer phantom to identify the primary frequency components in the original scattering spectrum. Simulated Mie spectra were also generated based on the manufacturer bead specifications. FFT of the simulated Mie spectra confirmed the frequency values obtained from the measured scattering spectra. Using the primary peaks determined from the single layer phantoms, the FFT amplitude of the three layer phantom was determined. The average of three trials was plotted as a function of probe-sample separation.

In Vivo Experiments

The 40 degree bevel fiber-optic probe was also evaluated in vivo on oral mucosal tissue of a normal volunteer. With the volunteer's consent, the probe was placed in direct contact with either the inner portion of the lower lip or the dorsal tongue. Three to four sites were measured for each anatomical location. The resultant reflectance spectra were normalized to one at 610 nm for comparison of the relative hemoglobin absorption measured by each collection fiber.

Results

The results demonstrate that collection BFs can be used to perform depth resolved spectroscopy, which has the potential to improve precancer detection and monitoring by accounting for epithelial thickening common in many precancerous and benign conditions.

Depth Selectivity Results

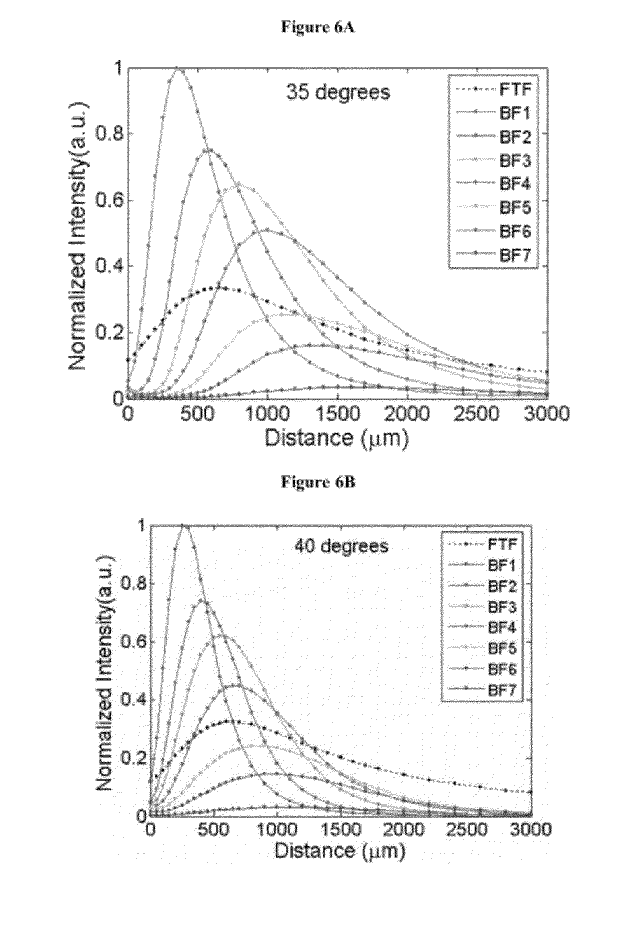

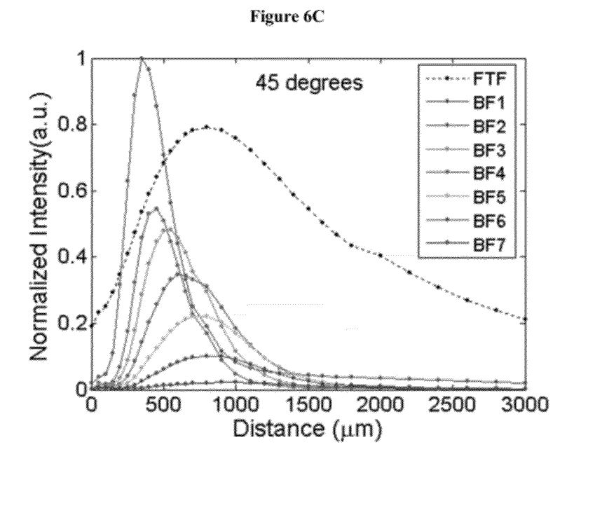

In some embodiments, the goal of a fiber-optic probe design is to isolate signals within a few hundred microns from the probe tip, to measure spectra from multiple depths (shallow, intermediate, and deep) simultaneously, and to have high collection efficiency. To explore these criteria, the depth profiling curves (total integrated intensity vs. probe-sample separation) for bevel angles 35, 40, and 45 degrees were plotted in FIGS. 6A, 6B and 6C. respectively. A peak in a curve indicates the distance from the endoscope, and hence the approximate depth into tissue, from which the majority of photons were sampled. BF1 corresponds to the collection BF with a source-detector separation of 110 μm. For all bevel angles, the collection BFs nearest to the source fiber interrogate most shallowly, while the collection BFs farthest from the probe tip interrogate more deeply.

The depth resolution can be quantified in terms of the maximum probing depth, i.e., the distance from the probe tip that has maximum signal intensity and the full width at half max (FWHM) of the depth profiling curves shown in FIGS. 6A-6C. The range of depths from which the collection fibers gather photons will depend on the amount of overlap between the collection cones of the collection fibers and the illumination beam of the illumination fiber, and will differ according to bevel angle and source-detector separation.

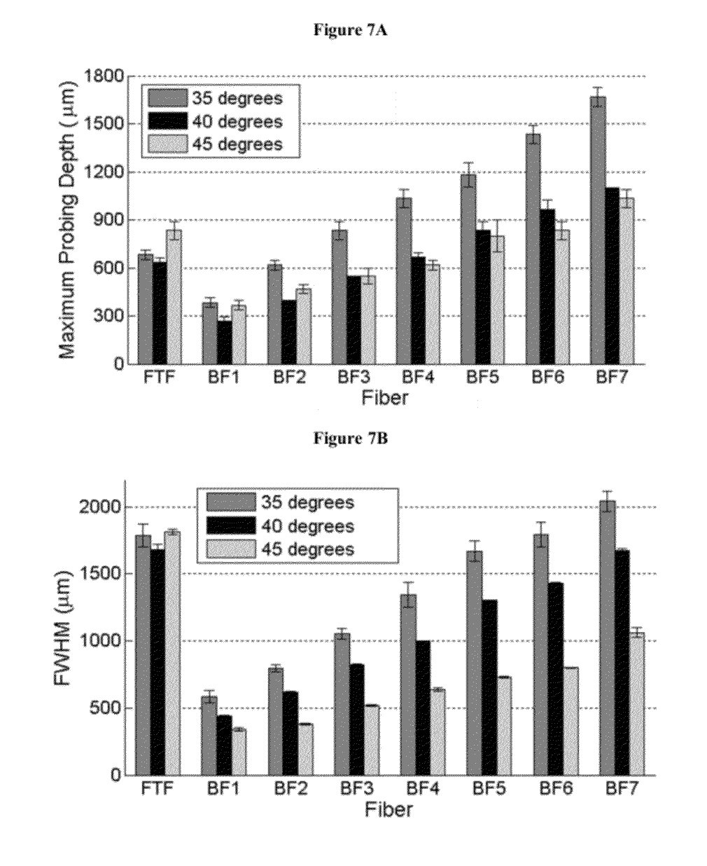

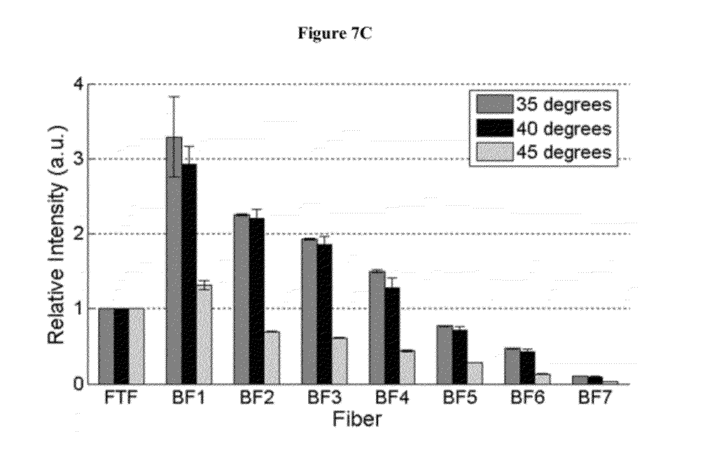

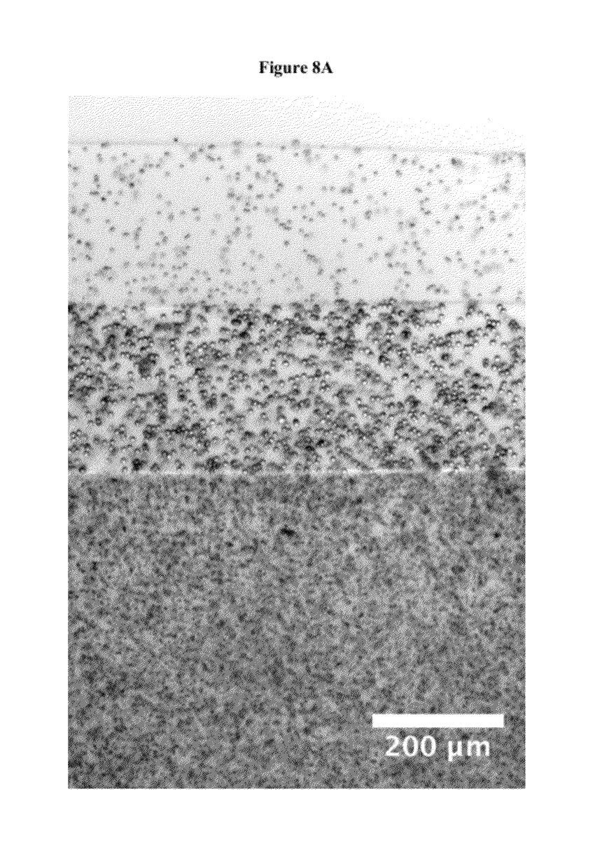

The maximum probing depth and standard error for each fiber is shown in FIGS. 7A. All fibers exhibit deeper penetration with the 35 degree bevel as compared to the 40 and 45 degree beveled fibers, which interrogate more shallowly. The FWHM and standard error for each collection fiber is shown in FIG. 7B. The FWHM increases for all fibers with increasing source-detector separation, as result of the diverging illumination beam and collection cones. The 35 degree beveled fibers have the largest FWHM for all fibers, while the 40 and 45 degree beveled fibers demonstrate better depth resolution.

Comparison to the collection FTF shows that the collection BFs closest to the illumination fiber have shallower probing depths as well as better depth resolution. The slight variation in the values for the maximum probing depth and FWHM for the collection FTF can be attributed to offset error in the point at which the probe is in direct contact with the white substrate. Normalization of the collected signal intensity with respect to the collection FTF is shown in FIG. 7C. Of note is the superior collection efficiency of the collection BFs closest to the illumination fiber. For all bevel angles, the collection efficiency drops rapidly with distance from the illumination fiber, i.e., increasing source-detector separation. The decrease in the relative intensity for 45 degree collection BFs is dramatic. The reason for this is believed to be two fold: the NA of the fibers is effectively decreased due to shielding from fibers closer to the source; and second, at bevel angles greater than 40 degrees, losses from Fresnel reflections at the air-fiber interface become appreciable. The bar graphs in FIG. 7 illustrate the trade off between signal intensity and depth localization.

Furthermore, an important consideration when using FTFs with small source-detector separations is the signal contribution due to specular reflection from the window. The specular reflection component is evident as a nonzero plateau in the depth profiling curve for the FTF in FIG. 6. The specular signal can be minimized by a) polishing the FTF at a slight angle; b) subtraction of the measured probe signal from a black substrate; and c) application of an antireflection coating. For the purposes of these experiments, the above procedures were not implemented in order to evaluate the specular reflection component of the FTFs and the BFs, which is less than 4% of the peak signal.

Phantom Experiment Results

The fiber-optic probe design with the 40 degree bevel was evaluated using multilayer tissue phantoms with scattering properties mimicking normal, precancerous, and stromal tissue. In this more realistic tissue environment, scattering blurred signal depth.

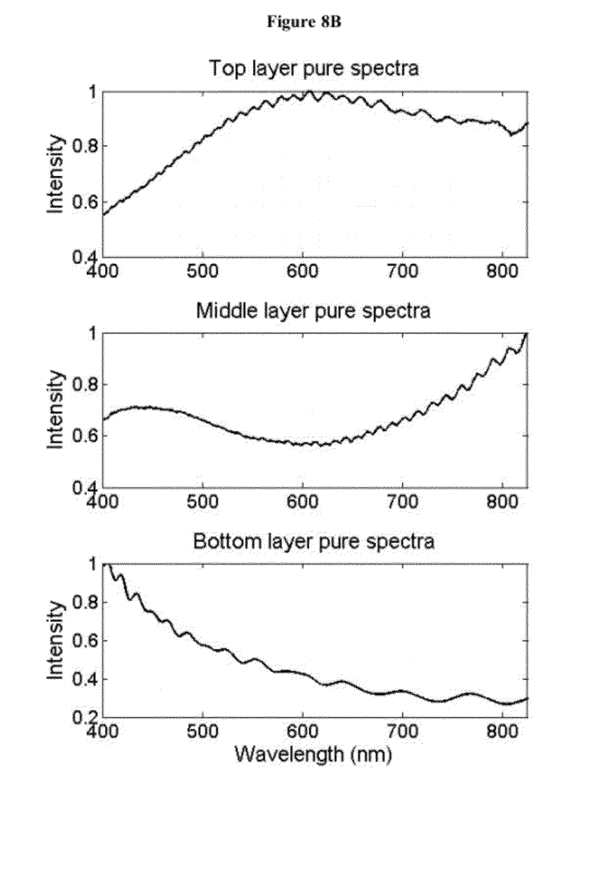

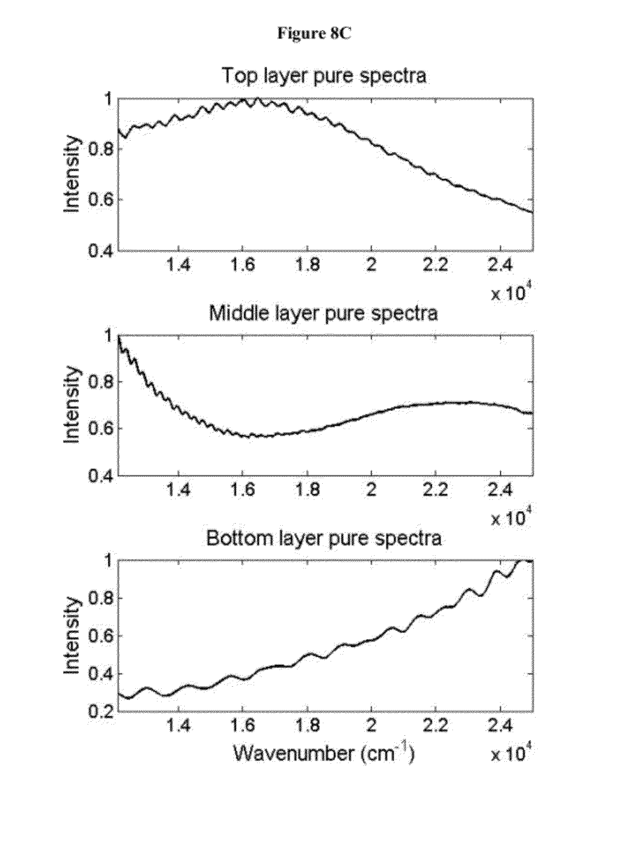

FIG. 8A shows a transverse cross-section through the three layer phantom imaged in transmittance bright field. The beads embedded in the top and middle layers are plainly visible in the image, while the bottom layer is almost opaque owing to the high concentration of beads required to reproduce the scattering conditions of stromal tissue. The top and middle layers are ca. 230 and 260 μm thick, respectively, and the bottom layer is ca. 6 mm to replicate a semi-infinite layer. In FIG. 8B, the scattering spectrum from each individual layer has a characteristic ripple frequency associated with bead size. The characteristic ripple frequency of each layer was used as a unique identifier for analysis of the depth profiling ability probe design under tissue-like conditions. The curves are smoothed using a 3.5 nm window.

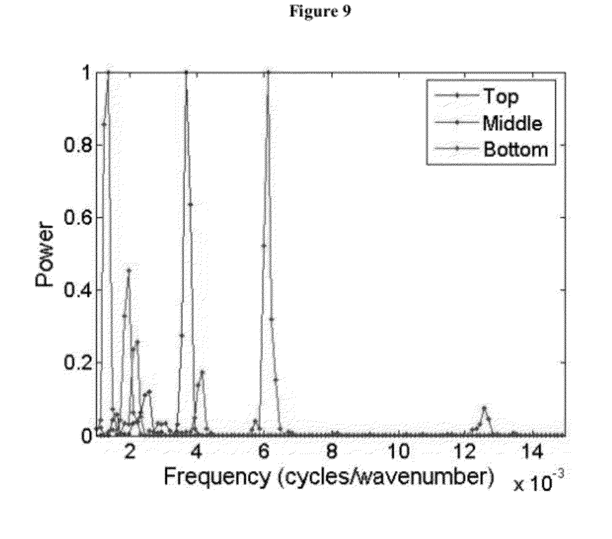

The measured spectra were plotted as a function of wavenumber in FIG. 8C. A fast Fourier transform (FFT) was taken of the measured spectrum (in wavenumber space) for each layer alone to identify the primary frequency components in the original scattering spectrum. FIG. 9 is a plot of the FFT power spectrum from the single layer phantoms illustrating the characteristic frequencies for the three different bead sizes.

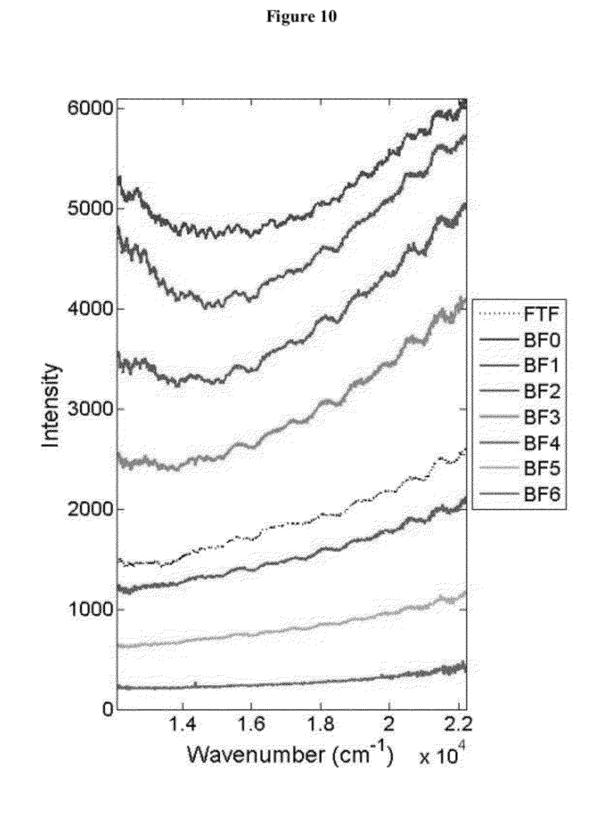

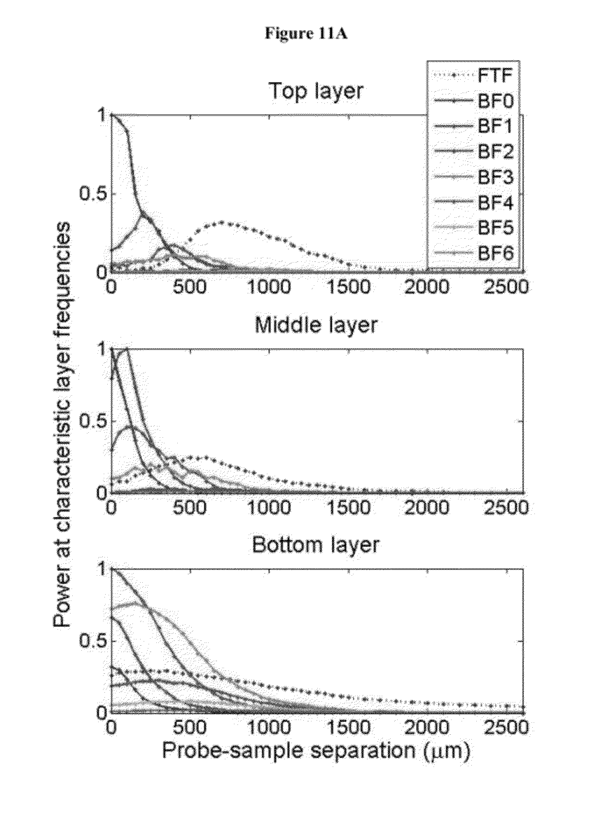

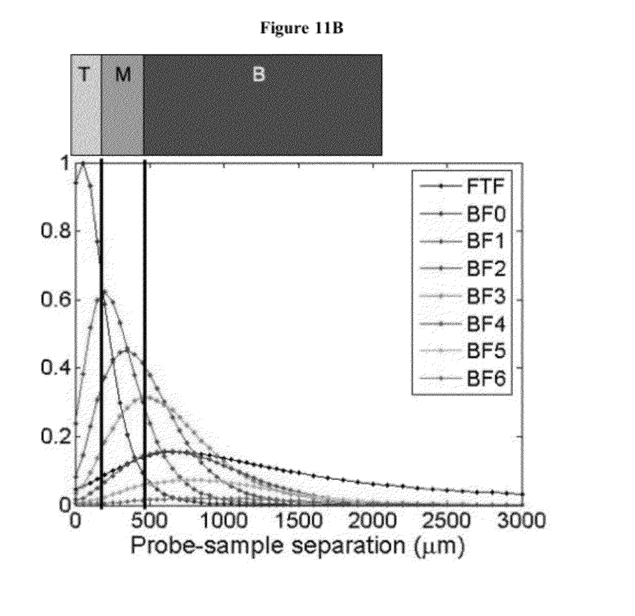

Given the primary frequency components of each layer obtained from Fourier analysis of the single layer phantoms, it was possible to track the contribution to the total collected scattering signal from a given layer as a function of distance from the probe tip. FIG. 10 is the measured scattering spectrum from the three layer phantom. Qualitatively, the characteristic bead ripple pattern for the top layer is visible in BF0. The middle layer ripple pattern stands out at small wavenumbers for BF1, while the bottom layer ripple pattern becomes more prominent for BF2-BF5.

FIG. 11A is a plot of the FFT amplitude of the characteristic frequency components for the top, middle, and bottom layer as a function of probe-sample distance. Similar to the white substrate measurements, the collection BFs closest to the illumination fiber sample the most shallowly and collection BFs farthest from the illumination fiber sample more deeply. FIG. 11B emphasizes this point, with an illustration of the phantom above the white substrate depth sampling profile for the collection fibers. The shape and order of the curves in FIG. 11A match the white substrate depth profiling plot shown in FIG. 11B, with the starting point of the FFT curves (zero probe-sample separation) corresponding to the approximate layer boundaries, which are shown by thick black lines in FIG. 11B. For example, at zero probe-sample separation, FIG. 11B indicates that the top layer should be preferentially probed by BF0, followed by BF1, BF2 and so on. Similarly, the middle layer should also be probed best by BF0, followed closely by BF1. The bottom layer should follow the pattern with the optimal probing by BF2, then BF3, and BF1. The FFT plots shown in FIG. 11A match the predictions based on the white substrate data. This result is noteworthy because it demonstrates that the beveled fiber design can provide depth resolution despite blurring of signal depth under typical scattering conditions.

The three layer phantom results demonstrate that a beveled fiber-optic design can provide depth resolution under scattering conditions similar to precancerous epithelial tissue.

In Vivo Results

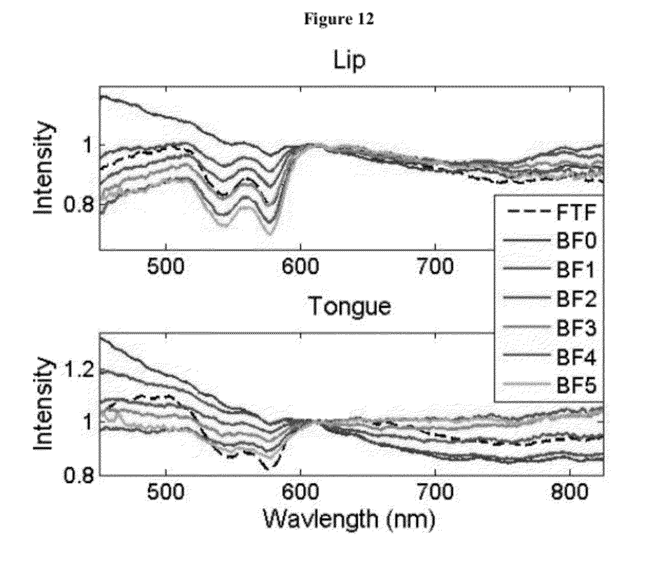

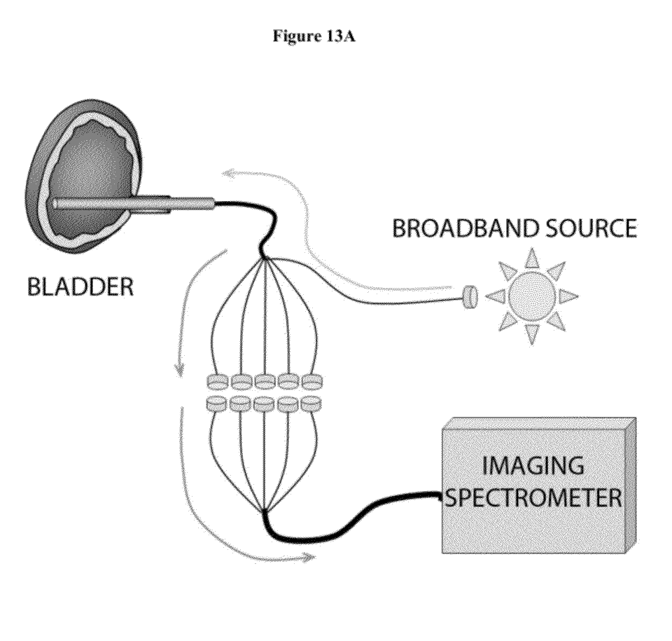

The 40 degree bevel probe was also evaluated in vivo on oral mucosal tissue of a normal volunteer. FIG. 12 shows representative measured spectra from the inside of the lower lip and the dorsal tongue of a normal volunteer. The spectra from BF6 were omitted for clarity. Absorption from oxygenated hemoglobin is shown as dips in the measured spectrum at 540 nm and 576 nm.

The amount of hemoglobin absorption in the scattering spectrum, owing to hemoglobin carrying capillaries in the stroma, is used as a benchmark to ascertain the depth of interrogation of the collection BFs. It is expected that collection fibers that interrogate more deeply will have larger hemoglobin absorption dips. In FIG. 12, the lip spectra demonstrates that the collection FTF has greater hemoglobin absorption dips as compared to BF0, BF1, and BF2, while in the tongue spectra the collection FTF shows the greatest hemoglobin absorption of all fibers. This indicates that the collection FTF is interrogating the underling stroma. For both tissue locations, the hemoglobin absorption dips increase with distance from the illumination fiber. This is especially evident for the beveled fibers, where BF0 has the smallest hemoglobin dips while BF5 has the largest absorption dips. The in vivo measurements further demonstrate the ability of a fiber-optic probe of the present disclosure to obtain depth resolved spectra.

The in vivo spectra shown in FIG. 12 demonstrates that hemoglobin absorption from the stromal layer increases for each successive beveled fiber, from BF0 to BF5. The ability to probe multiple depths is important for applications where the epithelial thickness varies. For example, benign conditions in the oral cavity often have hyperkeratinization or hyperplasia. Premalignant and malignant conditions can also have marked epithelial thickening. As a result, epithelial thickening, i.e., an increase in the distance from the top of the tissue to the top of the stroma, makes it difficult to assess the independent optical properties of the epithelium and stroma. Within the epithelium, the basal layer is of interest as the majority of cancers begin at this location. Epithelial thickening complicates targeting this sublayer, or the stroma, or the entire epithelium. Therefore, the ability to interrogate multiple depths becomes increasingly important.

Comparison of the inner lip and tongue spectra reveals epithelial thickening from keratinization. This is evident as diminished hemoglobin absorption in the tongue spectra as compared to the lip spectra in FIG. 12. Of note is the slope of the curves in the wavelength range 450-500 nm. A positive slope can be attributed to strong hemoglobin absorption at 420 nm while the lack of a strong absorption dip, indicated by a negative slope, can be attributed to epithelial thickening from keratinization. For the lip, all fibers show a positive slope, except for BF0, which probes most shallowly. This is consistent with the nonkeratinized structure of inner lip, where the hemoglobin containing capillaries are near the tissue surface. In contrast, all fibers except the FTF exhibit a negative slope in the tongue spectra, as is expected for keratinized masticatory tissue. These results demonstrate that the use of multiple depth sensitive collection fibers can provide the flexibility necessary to the select spectra from a targeted distance from the probe tip, thus, enabling in vivo study of the depth dependent changes that occur with precancer development.

Conclusions

As the majority of cancers are epithelial in origin, detection of the earliest precancerous changes in the epithelium, as well as corresponding alterations in the stroma has the potential to greatly impact detection and treatment. Typical flat-tipped spectroscopic probes interrogate a broad range of tissue depths, making it difficult to separate the spectral contributions from the epithelium and stroma. Mathematical algorithms have been developed to aid in the separation of these two signals; however, they often require a priori knowledge of the tissue or assumptions about its optical properties. This problem is compounded by precancers that have epithelial thickening and/or tissue keratinization.

Use of multiple depth sensitive fibers can ameliorate this difficulty, where each fiber interrogates a defined region beyond the probe tip. The fiber-optic probes of the present disclosure utilize multiple collection BFs and in some embodiments, a collection FTF. Measurements on a thin white substrate indicate that a 40 degree bevel provides the best compromise between signal intensity and depth resolution. Seven BFs were investigated, each with increasing distance from the source fiber. FIGS. 6 and 7 demonstrate that the BFs closest to the source fiber have the greatest signal intensity and shallowest interrogation depths. The relatively poor signal intensity for BFs farthest from the source fiber indicate that there is an upper limit on source-detector separation for beveled fibers. Hence, BFs may not be optimal for deep tissue interrogation. Use of FTFs, however, have better collection efficiency at larger depths and may be a better alternative for probing tissue deeply. In one embodiment, at zero separation, the peak probing depth is approximately 600 μm from the probe tip with a FWHM of ca. 1760 μm. Increasing the distance of the FTF from the source fiber will correspondingly increase the optimal sampling depth and therefore can be used as a complement to the shallow to intermediate depth information obtained with the beveled fibers.

### EXAMPLE 2

In this example, a fiber-optic probe of the present disclosure is utilized to discern early precancerous changes that precede detection by histopathology in an animal model of urinary bladder carcinogenesis. For this example, the focus was on bladder urothelium as there is a critical need for adjuvant surveillance tools for precancer detection, therapy assessment and biopsy guidance. Bladder cancer has an exceptionally high recurrence rate that can ultimately lead to death—approximately 50% of patients have tumor recurrence within the first 12 months after undergoing primary surgical treatment and up to 80% of patients redevelop tumors five years on. Early detection and better understanding of bladder carcinogenesis will provide direct improvement to patient care and reduction in the overall heath care burden since the high recurrence rate of bladder cancer makes it the most expensive human tumor from time of diagnosis to death.

To demonstrate the feasibility of multi-depth-sensitive optical spectroscopy for detection of neoplastic bladder changes, a rat bladder model of carcinogenesis was used. Carcinogen induced bladder cancer in rats is a key model for evaluation of novel therapies for bladder cancer because of its similarity to clinical disease. For this example, freshly excised bladders from rats were examined. Four rats were treated orally with 0.05% BBN (N-butyl-N-(4-hydroxybutyl)nitrosamine) in drinking water to induce bladder carcinogenesis. Two additional untreated rats were used as experimental controls, one for each time point. Rats were sacrificed at the 2 week and 4 week time point. Six to seven depth sensitive spectroscopy measurements were taken from each of the freshly excised bladders. Bladders were subsequently serially sliced and stained with hematoxylin and eosin (H&E) for microscopy analysis. Histopathology of the tissue slides reported that all bladders were nominally normal; indicating that the carcinogen exposed rats had not yet developed outward signs of tumor growth detectable by standard microscopy. After 5 weeks of BBN exposure, it is expected that foci of urothelial hyperplasia will become apparent and by week 20, papillary low-grade transitional cell carcinoma compatible with Stage Ta bladder tumor will manifest. Although structural alterations are not visible after 2 weeks of BBN exposure, several studies suggest that a high percentage of benign tissue has genetic damage that precedes carcinogenesis.

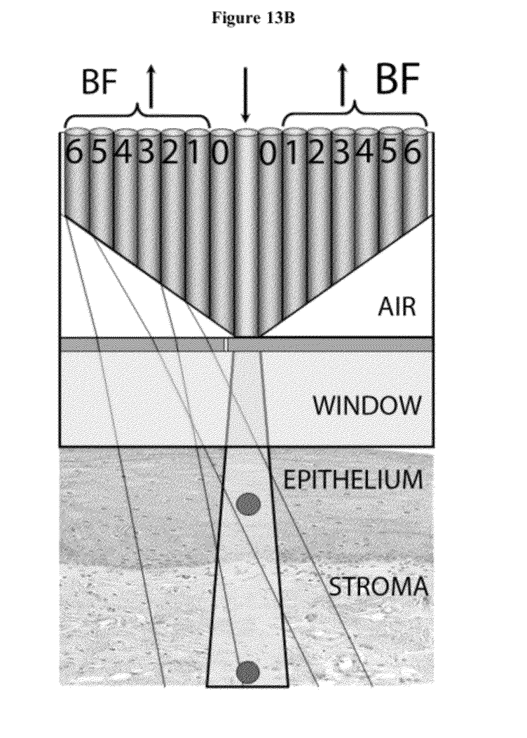

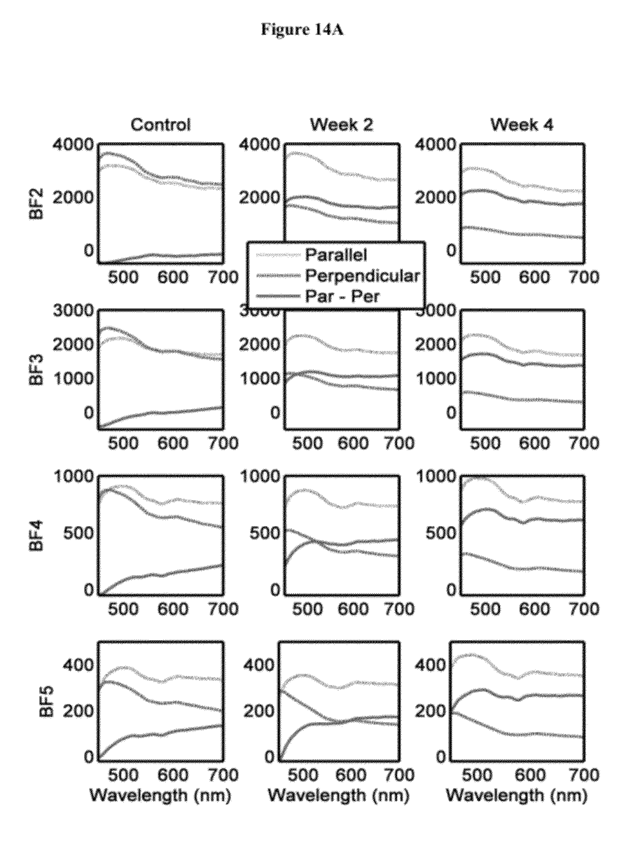

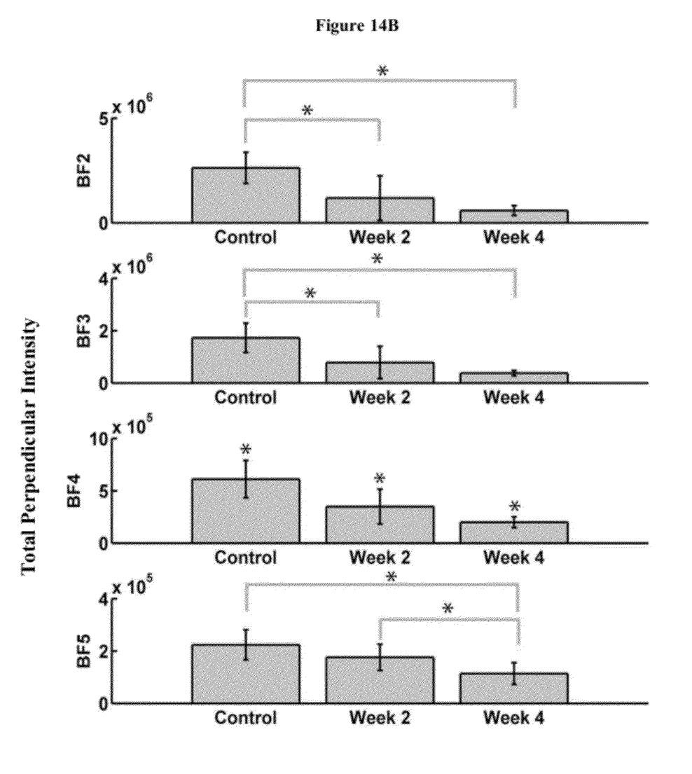

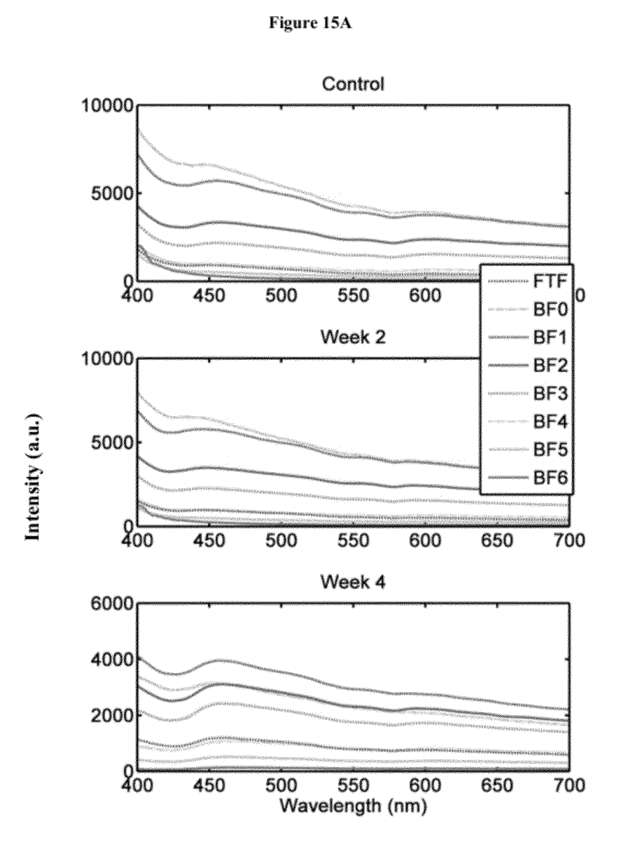

The system configuration and the distal end of the probe that was used in this example is shown in FIGS. 13A and 13B, respectively. Linear film polarizers were placed on the backside of the optical window for polarization studies. Due to the collection angle, beveled collection fibers (BF) close to the central source fiber (shown in yellow), probe more shallowly than BF's farther from the source fiber. The spectra for BF0-6 are shown in FIG. 14A. Analysis of variance (ANOVA) of the total perpendicular spectral intensity for each collection fiber shows statistically significant (p<0.05) differences between bladder types (see FIG. 14B). This difference can be attributed in part to epithelial thickening, because the perpendicular scattering signal is composed primarily of multiply scattered photons from the underlying stroma. As a consequence, any increase in the epithelial tissue layer effectively acts as a spacer between the collection fibers and the stroma and can therefore impact the collected perpendicular signal intensity. Sensitivity to urothelial thickness via the perpendicular collection channels is important since several urothelial conditions such as papillary hyperplasia, papilloma, and flat lesions have thickening of the urothelial layer. Moreover, premalignant and malignant conditions such as papillary urothelial neoplasms and carcinomas can have marked urothelial thickening. For a standard fiber optic endoscope configuration that interrogates a single large volume beyond the endoscope tip, variability in epithelial thickness can make it difficult to assess the independent optical properties of the epithelium and stroma for greater diagnostic sensitivity. Therefore, the ability to interrogate multiple depths, as allowed by a fiber-optic probe of the present disclosure, is critically important.

Direct microscopy measurements of the H&E rat bladder slides, reveal that the average epithelium thickness increased approximately 69% after 4 weeks of BBN exposure. Kruskal-Wallis ANOVA followed by pair-wise multi-comparison using Mann-Whitney U tests found that epithelial thickness for control and 2 week treated bladders were statistically equivalent while urothelial thickness of bladders exposed for 4 weeks to BBN were statistically greater (p=0). It is noteworthy that the total perpendicular spectral intensity collected by most individual BFs show statistical differences beyond that given simply by urothelial thickening. For example, BF5 achieves statistical significance across all three bladder types, as opposed to the change between only two bladder types (control and week 4) that is indicated by epithelial thickening alone. There are several possible explanations which are being investigated, including nuclear size enlargement between precancerous and healthy tissue.

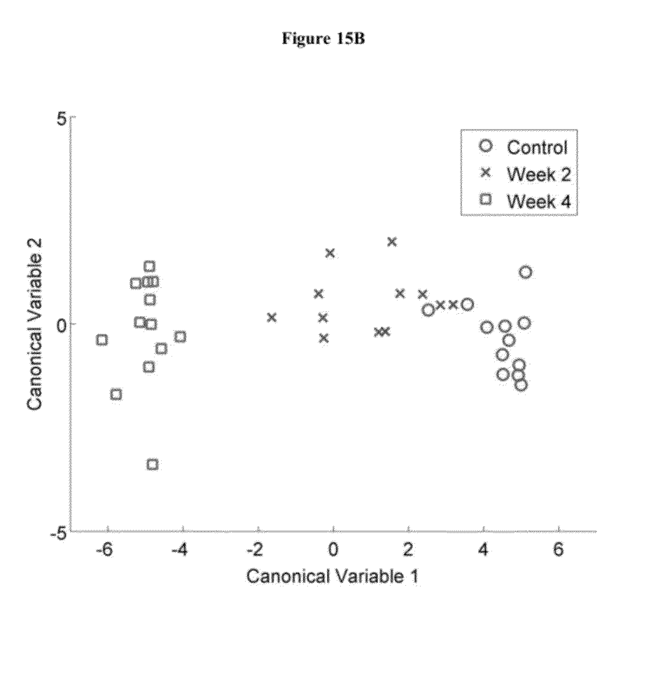

Use of a fiber-optic probe of the present disclosure, where each fiber in the probe interrogates a different region beyond the endoscope tip, permits flexibility to choose the fiber corresponding to the tissue region of interest for improved diagnostic discrimination. Furthermore, the capability to probe multiple depths simultaneously, allows the aggregate of all collection spectra to be used for diagnostic discrimination. For example, qualitative differences between the different rat bladder types emerge in the group of unpolarized (i.e. diffuse reflectance) spectra, shown in FIG. 15A. The spectra from the control bladders and those exposed for only 2 weeks appear almost identical in shape as well as ordering. However, after 4 weeks of BBN exposure, pronounced differences become apparent. Multivariate analysis of variance (MANOVA) of the spectral intensity information from all collection fibers, shown in FIG. 15B, demonstrates that all three bladder types are easily separable with p<0.001.

To further enhance the collection of urothelial tissue scattering as opposed to stromal tissue scattering, two types of differential spectroscopy approaches can be utilized. Both methods are based on the knowledge that singly scattered photons do not travel deeply into tissue and are therefore localized to the epithelial tissue layer. The first method, called differential path length spectroscopy (DPS), effectively minimizes the multiply scattered (i.e. stromal tissue scattering) contribution to the optical spectrum by taking the differential spectrum from adjacent collection fibers. DPS has shown much promise obtaining local optical property information from several organ sites, but has not been used in a depth sensitive manner as demonstrated in this example. MANOVA of DPS spectra show excellent separability for the different bladder types (p<0.001). Similarly, a depth-sensitive differential technique can be applied to polarized spectra. In this case, the spectrum of interest is the depolarization ratio spectrum, which is the difference between the parallel (co-polarized) and perpendicular (cross-polarized) spectra. Depolarization ratio spectra exhibit statistically significant separation of control rat bladders from those treated with BBN (p<0.001).

The results support work suggesting that spectroscopic detection of alterations in cellular nanoarchitecture parallels genetic events inflicted by carcinogen exposure. Early detection of precancerous changes not readily apparent with standard histopathology can dramatically impact identification and delineation of tissue regions with high probability for malignant transformation. This is especially pertinent to bladder cancer where the high recurrence rates give evidence to the lack of adequate removal of diseased tissue. Moreover, the ability to noninvasively observe subtle precancerous changes in tissue can be applied to post-treatment monitoring as well as biopsy guidance. While this study centers on bladder carcinoma, this approach can be translated to other organ sites and diseases where detection of subsurface tissue anomalies is of critical importance. Ultimately, enhanced sensitivity to neoplastic tissue alterations as a function of depth can lead to early detection and treatment, which can dramatically impact patient mortality, morbidity, and quality of life.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

Therefore, the present invention is well adapted to attain the ends and advantages mentioned as well as those that are inherent therein. While numerous changes may be made by those skilled in the art, such changes are encompassed within the spirit of this invention as illustrated, in part, by the appended claims.

### REFERENCES

1. R. Richards-Kortum, and E. Sevick-Muraca, “Quantitative optical spectroscopy for tissue diagnosis,” Annu Rev. Chem. 47, 555-606 (1996).

2. I. J. Bigio, and J. R. Mourant, “Ultraviolet and visible spectroscopies for tissue diagnostics: fluorescence spectroscopy and elastic-scattering spectroscopy,” Physics in Medicine and Biology 42, 803-814 (1997).

3. G. A. Wagnieres, W. M. Star, and B. C. Wilson, “In vivo fluorescence spectroscopy and imaging for oncological applications,” Photochem. Photobiol. 68, 603-632 (1998).

4. R. Cotran, V. Kumar, and S. Robbins, Pathologic basis of disease (1994).

5. I. Pavlova, K. Sokolov, R. Drezek, A. Malpica, M. Follen, and R. Richards-Kortum, “Microanatomical and Biochemical Origins of Normal and Precancerous Cervical Autofluorescence Using Laser-scanning Fluorescence Confocal Microscopy,” Photochem. Photobiol. 77, 550-555 (2003).

6. P. Zigrino, S. Loffek, and C. Mauch, “Tumor-stroma interactions: their role in the control of tumor cell invasion,” Biochimie 87, 321-328 (2005).

7. P. Carmeliet, “VEGF as a key mediator of angiogenesis in cancer,” Oncology 69, 4-10 (2005).

8. K. J. Heppner, L. M. Matrisian, R. A. Jensen, and W. H. Rodgers, “Expression of most matrix metalloproteinase family members in breast cancer represents a tumor-induced host response,” American Journal of Pathology 149, 273-282 (1996).

9. P. Friedl, “Dynamic imaging of cellular interactions with extracellular matrix,” Histochemistry and Cell Biology 122, 183-190 (2004).

10. R. K. Jain, “Determinants of tumor blood flow: a review,” Cancer Research 48, 2641-2658 (1988).

11. T. Collier, D. Arifler, A. Malpica, M. Follen, and R. Richards-Kortum, “Determination of epithelial tissue scattering coefficient using confocal microscopy,” IEEE Journal of Selected Topics in Quantum Electronics 9, 307-313 (2003).

12. I. Georgakoudi, E. E. Sheets, M. G. Muller, V. Backman, C. P. Crum, K. Badizadegan, R. R. Dasari, and M. S. Feld, “Trimodal spectroscopy for the detection and characterization of cervical precancers in vivo,” American Journal of Obstetrics and Gynecology 186 374-382 (2002).

13. M. G. Muller, T. A. Valdez, I. Georgakoudi, V. Backman, C. Fuentes, S. Kabani, N. Laver, Z. Wang, C. W. Boone, R. R. Dasari, S. M. Shapshay, and M. S. Feld, “Spectroscopic detection and evaluation of morphologic and biochemical changes in early human oral carcinoma” Cancer 97, 1681-1692 (2003).

14. J. R. Mourant, M. Canpolat, C. Brocker, O. Esponda-Ramos, T. M. Johnson, A. Matanock, K. Stetter, and J. P. Freyer, “Light scattering from cells: the contribution of the nucleus and the effects of proliferative status,” Journal Of Biomedical Optics 5, 131-137 (2000).

15. R. Drezek, M. Guillaud, T. Collier, I. Boiko, A. Malpica, C. MacAulay, M. Follen, and R. Richards-Kortum, “Light scattering from cervical cells throughout neoplastic progression: influence of nuclear morphology, DNA content, and chromatin texture,” Journal of Biomedical Optics 8, 7-16 (2003).

16. D. Arifler, M. Guillaud, A. Carraro, A. Malpica, M. Follen, and R. Richards-Kortum, “Light scattering from normal and dysplastic cervical cells at different epithelial depths: finite-difference time-domain modeling with a perfectly matched layer boundary condition,” Journal of Biomedical Optics 8, 484-494 (2003).

17. B. Chance, and B. Thorell, “Localization and kinetics of reduced pyridine nucleotide in living cells by microfluorometry,” J Biol Chem 234, 3044-3050 (1959).

18. R. Drezek, C. Brookner, I. Pavlova, I. Boiko, A. Malpica, R. Lotan, M. Follen, and R. Richards-Kortum, “Autofluorescence microscopy of fresh cervical-tissue sections reveals alterations in tissue biochemistry with dysplasia,” Photochem. Photobiol. 73, 636-641 (2001).

19. T. Collier, M. Follen, A. Malpica, and R. Richards-Kortum, “Sources of scattering in cervical tissue: determination of the scattering coefficient by confocal microscopy,” Journal of Biomedical Optics 44, 2072-2081 (2005).

20. U. Utzinger, and R. R. Richards-Kortum, “Fiber optic probes for biomedical optical spectroscopy,” Journal of Biomedical Optics 8, 121-147 (2003).

21. T. J. Pfefer, K. T. Schomacker, M. N. Ediger, and N. S. Nishioka, “Light propagation in tissue during fluorescence spectroscopy with single-fiber probes,” IEEE Journal of Selected Topics in Quantum Electronics 7, 1004-1012 (2001).

22. T. J. Pfefer, K. T. Schomacker, M. N. Ediger, and N. S. Nishioka, “Multiple-fiber probe design for fluorescence spectroscopy in tissue,” Applied Optics 41, 4712-4721 (2002).

23. T. J. Pfefer, L. S. Matchette, A. M. Ross, and M. N. Ediger, “Selective detection of fluorophore layers in turbid media: the role of fiber-optic probe design,” Optics Letters 28, 120-122 (2003).

24. T. Papaioannou, N. W. Preyer, F. Qiyin, A. Brightwell, M. Carnohan, G. Cottone, R. Ross, L. R. Jones, and L. Marcu, “Effects of fiber-optic probe design and probe-to-target distance on diffuse reflectance measurements of turbid media: an experimental and computational study at 337 nm,” Applied Optics 43, 2846-2860 (2004).

25. Z. Changfang, L. Quan, and N. Ramanujam, “Effect of fiber optic probe geometry on depth-resolved fluorescence measurements from epithelial tissues: a Monte Carlo simulation,” Journal of Biomedical Optics 8, 237-247 (2003).

26. Q. Liu, and N. Ramanujam, “Relationship between depth of a target in a turbid medium and fluorescence measured by a variable-aperture method,” Optics Letters 27, 104-106 (2002).

27. A. Amelink, and H. J. C. M. Sterenborg, “Measurement of the local optical properties of turbid media by differential path-length spectroscopy,” Applied Optics 43, 3048-3054 (2004).

28. R. L. P. v. Veen, A. Amelink, M. Menke-Pluymers, C. v. d. Pol, and H. J. C. M. Sterenborg, “Optical biopsy of breast tissue using differential path-length spectroscopy,” Physics in Medicine and Biology 50, 2573-2581 (2005).

29. M. P. L. Bard, A. Amelink, M. Skurichina, V. N. Hegt, R. P. W. Duin, H. J. C. M. Sterenborg, H. C. Hoogsteden, and J. G. J. V. Aerts, “Optical spectroscopy for the classification of malignant lesions of the bronchial tree,” Chest 129, 995-1001 (2006).

30. A. Amelink, O. P. Kaspers, H. J. C. M. Sterenborg, J. E. van der Wal, J. L. N. Roodenburg, and M. J. H. Witjes, “Non-invasive measurement of the morphology and physiology of oral mucosa by use of optical spectroscopy,” Oral Oncology 44, 65-71 (2008).

31. R. A. Schwarz, D. Arifler, S. K. Chang, I. Pavlova, I. A. Hussain, V. Mack, B. Knight, R. Richards-Kortum, and A. M. Gillenwater, “Ball lens coupled fiber-optic probe for depth-resolved spectroscopy of epithelial tissue,” Optics Letters 30, 1159-1161 (2005).

32. D. Arifler, R. A. Schwarz, S. K. Chang, and R. Richards-Kortum, “Reflectance spectroscopy for diagnosis of epithelial precancer: model-based analysis of fiber-optic probe designs to resolve spectral information from epithelium and stroma,” Applied Optics 44, 4291-4305 (2005).

33. J. T. Motz, M. Hunter, L. H. Galindo, J. A. Gardecki, J. R. Kramer, R. R. Dasari, and M. S. Feld, “Optical fiber probe for biomedical Raman spectroscopy,” Applied Optics 43, 542-554 (2004).

34. L. Nieman, A. Myakov, J. Aaron, and K. Sokolov, “Optical sectioning using a fiber probe with an angled illumination-collection geometry: evaluation in engineered tissue phantoms,” Applied Optics 43, 1308-1319 (2004).

35. T. J. Pfefer, A. Agrawal, and R. A. Drezek, “Oblique-incidence illumination and collection for depth-selective fluorescence spectroscopy,” Journal of Biomedical Optics 10, 44016-44441 (2005).

36. A. M. J. Wang, J. E. Bender, J. Pfefer, U. Utzinger, and R. A. Drezek, “Depth-sensitive reflectance measurements using obliquely oriented fiber probes,” Journal of Biomedical Optics 10, 44017-44041 (2005).

37. A. Myakov, L. Nieman, L. Wicky, U. Utzinger, R. Richards-Kortum, and K. Sokolov, “Fiber optic probe for polarized reflectance spectroscopy in vivo: design and performance,” Journal Of Biomedical Optics 7, 388-397 (2002).

38. L. T. Nieman, C.-W. Kan, A. Gillenwater, M. K. Markey, and K. Sokolov, “Probing local tissue changes in the oral cavity for early detection of cancer using oblique polarized reflectance spectroscopy: a pilot clinical trial,” Journal of Biomedical Optics, in press (2008).

39. D. Arifler, I. Pavlova, A. Gillenwater, and R. Richards-Kortum, “Light scattering from collagen fiber networks: micro-optical properties of normal and neoplastic stroma,” Biophysical Journal 92, 3260-3274 (2007).

40. J. N. Qu, C. Macaulay, S. Lam, and B. Palcic, “Optical-Properties of Normal and Carcinomatous Bronchial Tissue,” Applied Optics 33, 7397-7405 (1994).

41. S. K. Chang, D. Arifler, R. Drezek, M. Follen, and R. Richards-Kortum, “Analytical model to describe fluorescence spectra of normal and preneoplastic epithelial tissue: comparison with Monte Carlo simulations and clinical measurements,” Journal of Biomedical Optics 9, 511-522 (2004).

42. S. K. Chang, Y. N. Mirabal, E. N. Atkinson, D. Cox, A. Malpica, M. Follen, and R. Richards-Kortum, “Combined reflectance and fluorescence spectroscopy for in vivo detection of cervical pre-cancer,” Journal of Biomedical Optics 10, 11 (2005).

43. S. K. Chang, N. Marin, M. Follen, and R. Richards-Kortum, “Model-based analysis of clinical fluorescence spectroscopy for in vivo detection of cervical intraepithelial dysplasia,” Journal of Biomedical Optics 11, 12 (2006).

44. L. T. Perelman, V. Backman, M. Wallace, G. Zonios, R. Manoharan, A. Nusrat, S. Shields, M. Seiler, C. Lima, T. Hamano, I. Itzkan, J. Van Dam, J. M. Crawford, and M. S. Feld, “Observation of periodic fine structure in reflectance from biological tissue: a new technique for measuring nuclear size distribution,” Physical Review Letters 80, 627-630 (1998).

45. M. B. Wallace, L. T. Perelman, V. Backman, J. M. Crawford, M. Fitzmaurice, M. Seiler, K. Badizadegan, S. J. Shields, I. Itzkan, R. R. Dasari, J. Van Dam, and M. S. Feld, “Endoscopic detection of dysplasia in patients with Barrett's esophagus using light-scattering spectroscopy,” Gastroenterology 119, 677-682 (2000).

46. V. Backman, M. B. Wallace, L. T. Perelman, J. T. Arendt, R. Gurjar, M. G. M√°ller, Q. Zhang, G. Zonios, E. Kline, J. A. McGilligan, S. Shapshay, T. Valdez, K. Badizadegan, J. M. Crawford, M. Fitzmaurice, S. Kabani, H. S. Levin, M. Seiler, R. R. Dasari, I. Itzkan, J. Van Dam, and M. S. Feld, “Detection of preinvasive cancer cells,” Nature 406, 35-36 (2000).

47. R. A. Schwarz, W. Gao, D. Daye, M. D. Williams, R. Richards-Kortum, and A. M. Gillenwater, “Autofluorescence and diffuse reflectance spectroscopy of oral epithelial tissue using a depth-sensitive fiber-optic probe,” Applied Optics 47, 825-834 (2008).

48. F. Jaillon, W. Zheng, and Z. W. Huang, “Beveled fiber-optic probe couples a ball lens for improving depth-resolved fluorescence measurements of layered tissue: Monte Carlo simulations,” Physics in Medicine and Biology 53, 937-951 (2008).

49. Lovat, L. B., et al., “Elastic scattering spectroscopy accurately detects high grade dysplasia and cancer in Barrett's oesophagus.” Gut, 2006. 55(8): p. 1078-1083.

50. Mourant, J. R., et al., “Spectroscopic diagnosis of bladder cancer with elastic light scattering.” Lasers In Surgery And Medicine, 1995. 17(4): p. 350-357.

51. Georgakoudi, I., “The color of cancer.” Journal of Luminescence, 2006. 119: p. 75-83.

52. Nieman, L. T., M. Jakovljevic, and K. Sokolov, “Compact beveled fiber optic probe design for enhanced depth discrimination in epithelial tissues.” Optics Express, 2009. 17(4): p. 2780-2796.

53. Fleshner, N. E., et al., “The National Cancer Data Base Report on Bladder Carcinoma.” Cancer, 1996. 78(7): p. 1505-1513.

54. Hall, M. C., et al., “Guideline for the Management of Nonmuscle Invasive Bladder Cancer: (Stages Ta, T1, and Tis): 2007 Update.” Bladder Cancer, ed. A.U. Association. 2007: American Urological Association Education and Research, Inc.

55. Gofrit, O. N., et al., “Chemically induced bladder cancer—A sonographic and morphologic description.” Urology, 2006. 68(1): p. 231-235.

56. Junker, K., et al., “Molecular genetic evaluation of fluorescence diagnosis in bladder cancer.” International Journal of Oncology, 2002. 20(3): p. 647-653.

57. Matsuyama, H., et al., “Cytogenetic Analysis of False-Positive Mucosa by Photodynamic Diagnosis Using 5-Aminolevulinic Acid—Possible Existence of Premalignant Genomic Alterations Examined by in vitro Experiment.” Oncology, 2009. 76(2): p. 118-125.

58. Subramanian, H., et al., “Optical methodology for detecting histologically unapparent nanoscale consequences of genetic alterations in biological cells.” Proceedings of the National Academy of Sciences of the United States of America, 2008. 105(51): p. 20118-20123.

What is claimed is:

1. A fiber-optic probe comprising:
an illumination fiber; and
a plurality of collection beveled fibers.

2. The probe according to claim 1 further comprising a collection flat-tip fiber.

3. The probe according to claim 1 wherein the illumination fiber is an illumination flat-tip fiber.

4. The probe according to claim 1 wherein the plurality of collection beveled fibers have a distal end beveled at an angle between about 20 degrees to about 60 degrees.

5. The probe according to claim 1 wherein the plurality of collection beveled fibers have a distal end beveled at an angle of about 40 degrees.

6. The probe according to claim 4 wherein the illumination fiber has a distal end beveled at an angle that is the same as the distal end of the plurality of collection beveled fibers.

7. The probe according to claim 1 wherein the probe has a diameter of less than about 2 millimeters.

8. The probe according to claim 1 further comprising a polarizer.

9. The probe according to claim 1 wherein the illumination fiber and the plurality of collection beveled fibers are polarization maintaining fibers.

10. The probe according to claim 1 wherein the plurality of collection beveled fibers are arranged in a concentric ring around the illumination fiber.

11. A system comprising:
a fiber-optic probe operably connected to a spectrometer, wherein the fiber-optic probe comprises an illumination fiber and a plurality of collection beveled fibers.

12. The system according to claim 11 wherein the fiber-optic probe further comprises a collection flat-tip fiber.

13. The system according to claim 11 wherein the illumination fiber is an illumination flat-tip fiber.

14. The system according to claim 11 wherein the plurality of collection beveled fibers have a distal end beveled at an angle between about 20 degrees to about 60 degrees.

15. The system according to claim 11 wherein the plurality of collection beveled fibers have a distal end beveled at an angle of about 40 degrees.

16. The system according to claim 11 wherein the probe has a diameter of less than about 2 millimeters.

17. The system according to claim 11 wherein the fiber-optic probe further comprises a polarizer.

18. The system according to claim 11 further comprising an instrument for magnetic resonance imaging, computed tomography, or positron emission tomography, or optical coherence tomography.

19. A method comprising
placing a fiber-optic probe adjacent to a sample, wherein the fiber-optic probe comprises an illumination fiber and a plurality of collection beveled fibers;
illuminating at least a portion of the sample using the illumination fiber;
collecting remitted light from the sample using the plurality of collection beveled fibers; and
determining an alteration in an optical property of the tissue based at least in part on the remitted light.

20. The method of claim 19 wherein the sample comprises tissue of an esophagus, colon, lung, bladder, cervix, or artery.

21. The method of claim 19 wherein the sample comprises a contrast agent.

22. The method of claim 21 wherein the contrast agent is a plasmonic nanoparticle.

23. The method of claim 21 wherein the contrast agent is a fluorescent dye, a stain, or quantum dots.

24. The method of claim 19 wherein the probe further comprises a collection flat-tip fiber.

25. The method of claim 19 wherein the illumination fiber is an illumination flat-tip fiber.

26. The method of claim 19 wherein the plurality of collection beveled fibers have a distal end beveled at an angle between about 20 degrees to about 60 degrees.

27. The method of claim 19 wherein the plurality of collection beveled fibers have a distal end beveled at an angle of about 40 degrees.

28. The method of claim 19 wherein the illumination fiber has a distal end beveled at an angle that is the same as the distal end of the plurality of collection beveled fibers.

29. The method of claim 19 wherein the probe has a diameter of less than about 2 millimeters.

30. The method of claim 19 wherein the probe further comprises a polarizer.

31. The method of claim 19 wherein the illumination fiber and the plurality of collection beveled fibers are polarization maintaining fibers.

32. The method of claim 19 wherein the plurality of collection beveled fibers are arranged in a concentric ring around the illumination fiber.

33. The method according to claim 19 further comprising magnetic resonance imaging, computed tomography, or positron emission tomography.

34. The method according to claim 19 further comprising optical coherence tomography.
